(19) United States
(12) Patent Application Publication
(10) Pub. No.: US 2004/0181799 A1
(43) Pub. Date: Sep. 16, 2004

(54) Apparatus and method for measuring tuning of a digital broadcast receiver

(75) Inventors: Daozheng Lu, Dunedin, FL (US); Keqiang Deng, Safety Harbor, FL (US)

Correspondence Address: James A. Flight, GROSSMAN & FLIGHT, LLC, Suite 4220, 20 North Wacker Drive, Chicago, IL, 60606, US

(73) Assignee: Nielsen Media Research, Inc.

(21) Appl. No.: 10/811,543

(22) Filed: Mar. 29, 2004

Related U.S. Application Data
(63) Continuation of application No. 09/748,961, filed on Dec. 27, 2000, now abandoned.

(51) Int. Cl. H04N 7/173; H04H 9/00; H04N 7/16; H04H 1/00

(52) U.S. Cl. 725/18; 725/19; 725/131; 725/139

(57) ABSTRACT

An apparatus identifies a program selected for reception on a monitored receiver. The monitored receiver has a receiver output, and the selected program is one of a plurality of receivable programs. The apparatus includes a tuner and demodulator arranged to receive a predetermined one of the programs. A first feature extractor extracts a first set of characteristic features from the receiver output. A second feature extractor extracts a second set of characteristic features from the predetermined program. A comparator compares the first and the second sets of characteristic features. A code extractor extracts a program identifying code from the predetermined program if the first and the second sets of characteristic features match.

### CROSS REFERENCE TO RELATED APPLICATIONS

The present application presents subject matter similar to subject matter disclosed in the following applications: U.S. application Ser. No. 09/076,517 filed on May 12, 1998; U.S. application Ser. No. 09/116,397 filed on Jul. 16, 1998; U.S. application Ser. No. 09/427,970 filed on Oct. 27, 1999; and, U.S. application Ser. No. 08/428,425 filed on Oct. 27, 1999.

### TECHNICAL FIELD OF THE INVENTION

The present invention relates generally to the field of broadcast audience measurement and, more specifically, to an apparatus and method for generating tuning data for digitally broadcast programs.

### BACKGROUND OF THE INVENTION

Measurements of the audiences of analog television and radio broadcasts have long been made with equipment placed in statistically selected households. Such equipment monitors the channels to which each receiver in the household is tuned and stores the tuned channels as a sequence of time-stamped tuning records in a local memory. The stored tuning records are subsequently forwarded to a central office where they are compared with separately collected reference data. The reference data include a compiled list of all the programs available to the household on each receivable channel during each time period of interest, and are commonly referred to as program listings, station listings, cable listings, and/or the like. Although the process of comparing a tuned channel with a listing to uniquely identify which program had been viewed is a simple operation, collecting all the required reference data, assembling the reference data into listings, and assuring the accuracy of the listings is a burdensome task.

These operations are even more burdensome in the context of digital television. A variety of digital television broadcasting standards have been proposed and are being adopted in many countries. These broadcasting standards vary by transmission method (e.g., terrestrial broadcast, cable transmission, direct satellite broadcast, etc.) and, at least for the cable and terrestrial broadcast versions, from one region of the world to another. Although the various systems are not generally interoperable, they usually involve the time-division multiplexed transmission of sequences of data packets, such as data packets configured according to the MPEG-2 standard.

Because of the data compression methodology inherent in these broadcast standards, it is possible to multiplex several broadcast programs in each RF channel that had heretofore been adequate for only a single analog broadcast. For example, in the U.S. and Canada, the ATSC digital broadcast standard allows for the transmission of 19 Mbits/second in a 6 MHZ bandwidth. This ATSC bit rate can support transmission of a single high definition TV program (HDTV) or of several “standard definition” TV programs (SDTV) in each RF channel. Moreover, this ATSC bit rate also permits non-program related data to be co-transmitted with television programming. Thus, conversion of an analog NTSC channel to a digital broadcasting format permits each RF channel to carry several subchannels of SDTV and perhaps several low data rate services.

A similar situation is encountered in considering replacement of other analog television systems (such as PAL or SECAM) with other digital standards, such as the European Union's DVB-T or variants thereof such as ISDB-T (proposed for use in Japan) or NorDig. The multiplexing of multiple broadcast programs and data services in each RF channel increases the amount of information that can be broadcast and can, therefore, introduce possible ambiguities into audience measurements based upon channel detection.

Thus, a changeover from analog to digital television broadcasting renders obsolete the long established television audience measurement approaches that measure a channel number or frequency and then compares that measurement with a program record to determine what was viewed. In a digital broadcast scenario, because of the possibility of multiplexing multiple subchannels in each RF channel, determining the channel frequency of the transmission may not uniquely identify a program selected by a panel member for viewing.

Even though frequency measurement methods used for measuring tuning to analog television stations generally fail to provide unambiguous results when applied to digital television, many of the other approaches used for measuring tuning of analog receivers can be carried over to the new environment. These approaches include at least the following: i) signal correlation between a viewer-selected signal and a corresponding signal tuned by a reference scanning tuner disposed within the metered premises (a method often called “real time correlation;” ii) a correlation between signatures (i.e., feature sets) extracted from the viewer selected program and a set of corresponding reference signatures extracted from each of the programs as selected by a reference tuner at corresponding times; and, iii) the identification of viewer selected programs by reading ancillary codes broadcast with the programs.

A major advantage of real time correlation methods using program audio is that they can be non-intrusive if a microphone, for example, is used to pick up the sound of a selected program from a television or radio speaker. However, in the digital environment, the digital receiver (radio, television, etc.) may introduce a delay between the time that the audio data is received and the time that the audio is reproduced by speakers. This delay varies according the decoding method used inside the receiver. Thus, it is difficult to directly carry real time correlation over to the digital domain. Even after the delay problem is solved, these methods can only provide an indication of the tuned broadcast source (e.g., the tuned channel in the case of an analog transmission, or the channel and subchannel in case of a digital broadcast), and require additional central office operations in order to determine the program that was available on the tuned channel or subchannel. Additionally, a digital television can carry more audio programs than an analog television because of audio compression. As the number of audio programs increases, the scanning time increases as well. Without a proper control of scanning, the average time needed to find the correct subchannel will be too long to be of any practical use when digital broadcasting is fully rolled out.

Signature approaches have also been proposed to monitor program content tuned by a metered receiver. These systems generally extract broadcast signatures from the programs to which the metered receiver is tuned and compare these broadcast signatures with corresponding reference signatures previously extracted from reference copies of these programs (e.g., extracted from distribution tapes) or from previous broadcasts of a program (e.g., a commercial). For example, U.S. Pat. No. 4,697,209, which is assigned to the same assignee as the current invention, discloses a program monitoring system in which broadcast signatures are collected in sampled households at instants determined by the program content (e.g., at a predetermined time after a scene change in the video portion of a monitored program). These broadcast signatures are subsequently compared to reference signatures collected by reference equipment tuned to broadcast sources available in the selected market. In this system, matching a broadcast signature with a reference signature is used to identify the program being viewed and not just the channel on which it is transmitted.

However, systems which rely upon signature extraction to identify programs are computationally expensive so that their use has been somewhat restricted by the cost of computer hardware. Additionally, such systems rely on reference measurement sites to collect reference signatures from known program sources. When one set of reference equipment fails, all reference signature data for that program source may be lost.

The ancillary code approach involves labeling each program with an ancillary code. For example, in analog television broadcasts, a digital code is written on a selected line in the vertical blanking interval of each program to be monitored. This ancillary code is then read in the sampled households and subsequently compared (e.g., in a central office computer) to ancillary codes stored in a code-program name library. The code-program name library contains a manually entered listing of program names and the codes associated therewith. Thus, given an ancillary code of a program selected for viewing and/or listening in a sampled household, the program name can be easily determined from the library.

Historically, ancillary code arrangements have not been totally successful both because they require all possible programs to be encoded before a complete measurement can be made, and because they require an ancillary code that can reliably pass through a variety of distribution and broadcasting processes without being stripped or corrupted to the point of illegibility. This latter problem is particularly acute in digital television where program signals are encoded using various data compression techniques in the transmitter and then decoded using complementary decompression techniques in the receiver.

In analog program distribution, the various sorts of identifying codes that have been used are irrelevant to the basic broadcast function. In the digital television distribution environment, on the other hand, some codes are an integral part of the transmission process, although it is not yet clear if the industry will adopt standards providing additional levels of identification useful to audience measurements. The various digital broadcast standards all call for the transmission of digital data packets, each of which carries an identifying label. Because multiple subchannels may share a given RF frequency, the receiving equipment uses the identifying label in order to determine whether a given packet belongs to a user-selected subchannel or is something to be ignored. Moreover, the data compression used in digital transmission relies on sending different types of packets (e.g., a “new scene” packet may be followed by a string of packets providing updates to a slowly changing image). Therefore, the packet label is also used to tell the receiver how the packet is to be processed.

Proposed television transmission standards generally go well beyond these labeling requirements needed for transmitting packetized digital data, and provide for a wide variety of additional code fields, including fields identifying the program (program name, episode label, etc.), its origination time and place, and its scheduled broadcast time.

The present invention is directed to an arrangement addressing one or more of the above-noted problems associated with identifying the digital programs selected for viewing and/or listening.

### SUMMARY OF THE INVENTION

In accordance with one aspect of the present invention, a method is provided to determine which of a plurality of programs has been selected to be received by a monitored receiver. Each of the programs has an audio signal portion and is transmitted as a sequence of data packets in a corresponding channel. The monitored receiver has a receiver audio output representative of an audio signal portion of the selected program. The method comprises the following: a) comparing the receiver audio output with the audio signal portion of each of the programs until a match is found; b) reading an identifying code from one of the data packets associated with the matching program; and, c) storing the identifying code as a time-stamped record in a memory apparatus.

In accordance with another aspect of the present invention, an apparatus identifies a program selected for reception on a monitored receiver. The apparatus comprises a tuner and demodulator, first and second feature extractors, a comparator, and a code extractor. The monitored receiver has an audio output. The selected program is one of a plurality of receivable programs. Each of the plurality of receivable programs is distributed as a time-division sequence of data packets at a corresponding one of a plurality of radio frequencies. The tuner and demodulator receives a predetermined one of the receivable programs. The first feature extractor extracts a first set of characteristic features from the audio output. The second feature extractor extracts a second set of characteristic features from the predetermined program. The comparator compares the first and the second sets of characteristic features and determines if the first and the second sets of characteristic features match. The code extractor extracts a program identifying code from the predetermined program.

In accordance with yet another aspect of the present invention, a method is provided to determine which of a plurality of programs has been selected to be received by a monitored receiver. Each of the programs is transmitted as a sequence of data packets in a corresponding channel. The monitored receiver has a receiver output representative of the selected program. The method comprises the following: a) comparing the receiver output with each of the plurality of programs until a match is found; and, b) reading an identifying code from one of the data packets associated with the matching program.

In accordance with a further aspect of the present invention, a method is provided to determine which of a plurality of programs has been tuned by a monitored receiver. Each of the programs is transmitted as a sequence of data packets in a corresponding channel, and the monitored receiver has a receiver output representative of the selected program. The method comprises the following: a) determining a test power spectrum based upon the receiver output; b) determining a plurality of reference power spectra based upon the plurality of programs; c) comparing the test power spectrum with each of the reference power spectra, as necessary, to determine a match; and, d) determining an identification indicia based upon the match.

### BRIEF DESCRIPTION OF THE DRAWINGS

These and other features and advantages of the present invention will become more apparent from a detailed consideration of the invention when taken in conjunction with the drawings in which:

FIG. 1 is a schematic block diagram of a measurement system according to the present invention;

FIG. 2 is a schematic block diagram providing additional detail of the block labeled DMD in FIG. 1; and,

FIG. 3 is a schematic depiction of two matched signals that have been processed by a Fast Fourier Transform.

### DESCRIPTION OF THE PREFERRED EMBODIMENT

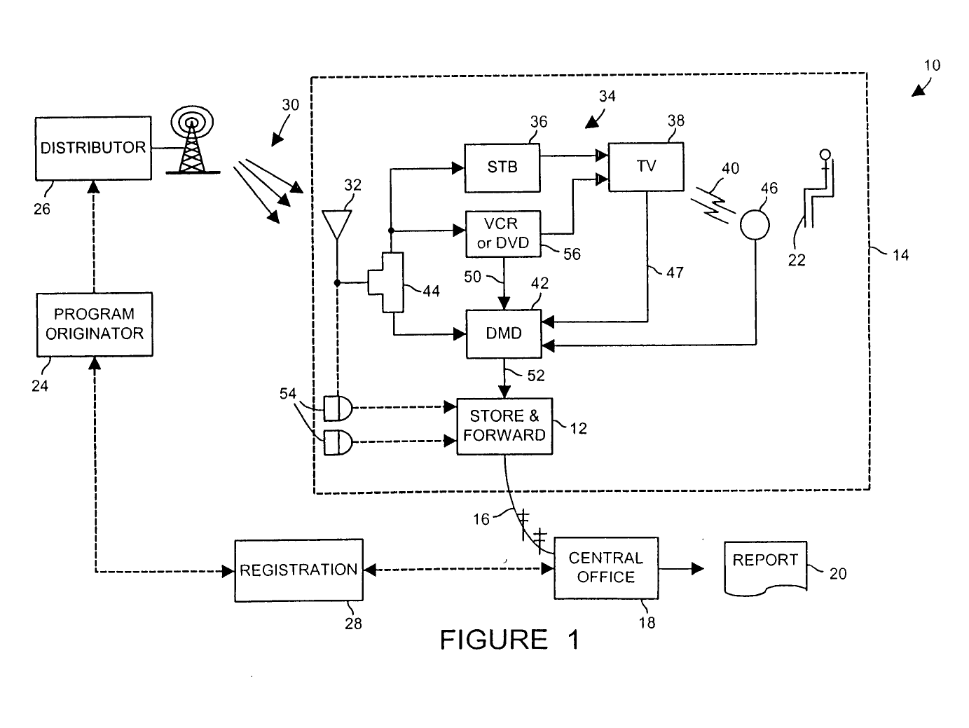

A system 10 according to an exemplary embodiment of the present invention is illustrated in FIG. 1 and may share many features with known audience measurement systems. For example, as in the case of known measurement systems, the system 10 includes a store and forward device 12 within a statistically selected dwelling 14 in order to store tuning data that can be later forwarded over a public switched telephone network 16 to a central office 18 for the production of television rating reports 20 and the like. Although some of the features of known measurement systems are depicted in FIG. 1, it should be understood that many other compatible features, such as a manual identification entry device permitting an audience member 22 to identify himself or herself, or a passive identification device in which the audience member 22 is passively and automatically identified, have been omitted from the drawing in the interest of clarity and brevity of presentation. The audience member 22 may be a member of a statistically selected panel that is established to provide statistical information to a researcher about program selection. Accordingly, the audience member 22 may be alternatively referred to as a panelist.

In an exemplary digital broadcasting arrangement, a program originator 24 sends a digitally mastered television program (such as a drama, a sitcom, a commercial, a documentary, a promo, a public service announcement, etc., or a portion thereof) to a distributor 26, such as a broadcaster, for distribution in a service area encompassing the statistically selected dwelling 14. A program may have any length.

The program has embedded in it an identification code (e.g., a code such as that specified in ATSC Standard A57, which was issued by the Advanced Television System Committee on Aug. 30, 1996, and/or any of the codes provided in the proposed broadcast standards discussed above, and/or any other codes or marks from which the identification of a station or channel or program source can be identified or distinguished). As appropriate, all or part of the identification code may be assigned by a registration authority 28 (e.g., the Society of Motion Picture and Television Engineers). The encoded program may be combined with other programs as a time-division multiplexed sequence of digital signal packets for distribution in a television channel. This distribution may be received in the statistically selected dwelling 14 and is selectively processed to provide visual and/or audible signals to the audience member 22.

For example, the programs may be terrestrially broadcast as RF signals 30 which are picked up by an antenna 32. A user selected RF channel picked up by the antenna 32 is tuned and demodulated in a monitored digital receiver 34, which may include, for example, a set top box 36 and/or a television 38. The television 38 may be a digital television, or the television 38 may be an analog television, in which case the set top box 36 converts the received digital broadcast signals to analog signals for display on the analog television. The television 38 includes a speaker (not shown) emitting an audible output signal 40.

Although FIG. 1 schematically depicts a terrestrial broadcasting distribution arrangement in which the RF signals 30 are picked up by the antenna 32, those skilled in the art will realize that many other distribution arrangements are possible and are widely described in standards and other literature relating to digital television. For example, instead of terrestrially broadcasting the RF signals 30, the RF signals 30 may be transmitted via cable or satellite. Moreover, although the set top box 36 and the television 38 are shown as separate units, any combination of them may be enclosed within a single housing. Also, according to the present invention, the monitored digital receiver 34 may be a digital video recorder, a game, a radio, a computer, and/or the like.

A digital measurement device 42 is connected by a splitter 44 to the antenna 32 so that the digital measurement device 42 has access to all available television program signals, radio program signals, and/or the like. Also, the digital measurement device 42 has access to either the audio signal of the program selected by the audience member 22 or a replica of this audio signal. This audio signal may be non-invasively acquired such as by a microphone 46 or an audio output coupling 47 from an audio signal output connector that is a part of the monitored digital receiver 34. The choice of whether to couple the digital measurement device 42 to the microphone 46 or to an audio output of the monitored digital receiver 34 over the audio output coupling 47 depends upon the type of consumer program receiving equipment that the installer encounters in the statistically selected dwelling 14.

The digital measurement device 42 has an output 52 coupled to the store and forward device 12 that also receives tuning data from other monitored receivers 54 disposed in the same statistically selected dwelling 14. During a transition period when both analog and digital broadcasts are available and may be used in the same statistically selected dwelling 14, the other monitored receivers 54 may include digital and/or analog receivers.

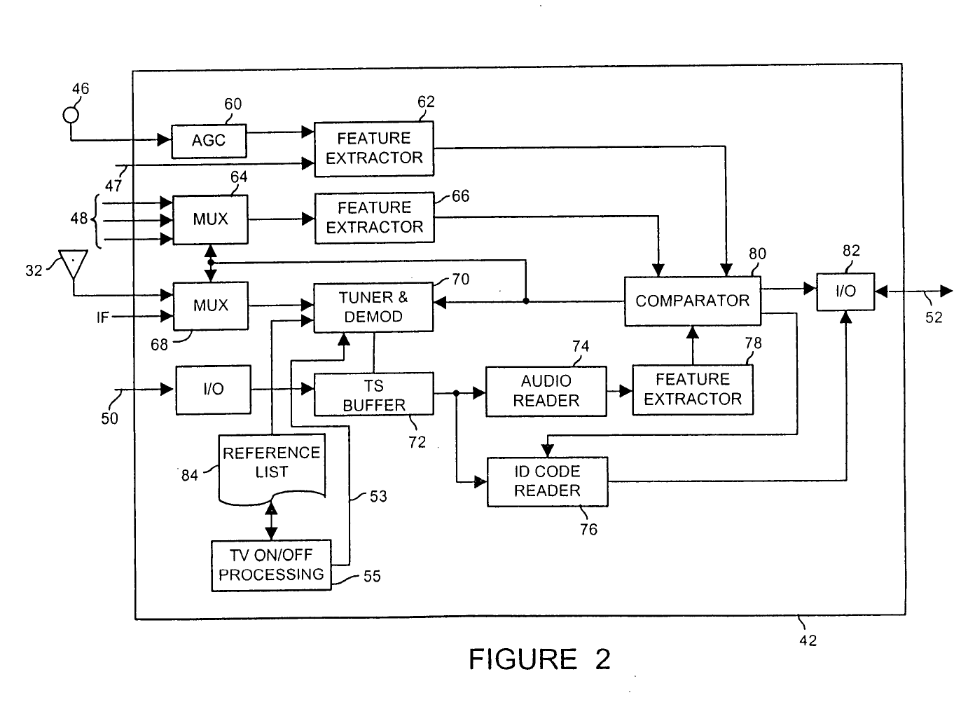

The digital measurement device 42 is shown in additional detail in FIG. 2. The measurement inputs to the digital measurement device 42 include the microphone 46, a receiver on/off signal 53 from an on/off processor 55 coupled to an on/off detector (not shown) , the audio output coupling 47, one or more audio and/or video inputs 48 from one or more analog receivers located within the statistically selected dwelling 14, and/or an input 50 that may be available from a digital playback device 56 (see FIG. 1).

The measurement input signal from the microphone 46 is brought to a standard range of intensity by an automatic gain control circuit 60 and is supplied to a test feature extractor 62 as an audio output signal (or audio test signal) representative of a tuned program. When the audio output coupling 47 is available from the monitored television, the audio output coupling 47 is coupled to the test feature extractor 62 as an audio output signal representative of a tuned program. The operation of the test feature extractor 62 will be hereinafter described.

In addition to these tuning inputs, the digital measurement device 42 acquires a plurality of reference inputs representative of all the tuning choices available to the audience member 22. These reference inputs may be derived from a radio frequency source, such as the antenna 32, from intermediate frequency sources, from the one or more audio and/or video inputs 48, and/or from the input 50, which may carry a digital transport stream and which may adhere to the IEEE 1394 (also known as “firewire”) and/or PC industry's USB2 (Universal Serial Bus—2) standards that are proposed for use in interconnecting various digital consumer broadcast equipment (e.g., a digital TV and a digital VCR). These reference inputs are recorded in a reference list 84 shown in FIG. 2. Thus, for example, the reference list 84 may store all of the possible channels and/or sources available to the receiving equipment in the statistically selected dwelling 14.

The reference inputs derived from the one or more audio and/or video inputs 48 are selected by a multiplexer 64, and the selected one of the one or more audio and/or video inputs 48 is supplied to an analog reference feature extractor 66 which may operate similarly to the test feature extractor 62.

The reference inputs derived from the radio frequency source, such as the antenna 32 or an intermediate frequency source, are selected by a multiplexer 68 and are tuned and demodulated by a tuner and demodulator 70 in order to provide a reference transport bitstream. Because the antenna 32 delivers a plurality of channels to the tuner and demodulator 70, the tuner and demodulator 70 preferably includes a scanning tuner to scan through each of the channels available from the antenna 32 so that all reference channels can be scanned in a dynamic order, and so that the programs carried in each reference channel can be compared in parallel to the audio output from the monitored digital receiver 34. In order to more efficiently scan only the available channels and/or sources and to avoid wasteful scanning of channels and/or sources not available to the receiving equipment in the statistically selected dwelling 14, the scanning tuner may refer to the reference list 84 which stores the available channels and/or sources. The reference transport bitstream recovered by the tuner and demodulator 70 is temporarily stored in a transport bitstream buffer 72. Also, the reference input derived from the input 50 is coupled directly to the transport bitstream buffer 72 because this reference input is already in the form of a transport bitstream.

The reference transport bitstreams temporarily stored in the transport bitstream buffer 72 are passed to an audio bitstream reader 74 which extracts all audio data within the tuned reference source. At the same time, a code reader 76 extracts the identity codes associated with the audio data. The audio data extracted by the audio bitstream reader 74 are passed to an audio bitstream reference feature extractor 78.

The code reader 76 temporarily stores the identity codes it extracts pending a determination by a comparator 80 as to whether it finds a match between the audio output signal representative of a tuned program as extracted by the test feature extractor 62 and the current reference feature set which is extracted by the audio bitstream reference feature extractor 78 and which corresponds to one of the channels (and/or sources) available to the monitored digital receiver 34. If a match is found, the identification code stored by the code reader 76 is output through an input/output interface 82 to the store and forward device 12 over the output 52. The store and forward device 12 time stamps the identification code and stores the time stamped identification code as a record to be forwarded to a central office. If a match is not found, the comparator 80 controls the multiplexer 68 and/or the tuner and demodulator 70 to select a next input and/or channel until a match is found.

In performing a comparison, the comparator 80 is arranged to compare the reference feature set extracted by audio bitstream reference feature extractor 78 from the audio portion of the reference transport bitstream temporarily stored in the transport bitstream buffer 72 to the test feature set extracted by the test feature extractor 62. In a digital broadcast environment, the RF channel (major channel) selected by the scanning tuner of the tuner and demodulator 70 may contain several sub-channels (minor channels). In this situation, the comparator 80 may be arranged to compare the reference feature sets corresponding to the several sub-channels in parallel to the reference feature set. Alternatively, the comparator 80 may be arranged to compare the reference feature sets corresponding to the several sub-channels one at a time to the reference feature set. As a still further alternative, the scanning tuner of the tuner and demodulator 70 may be arranged to scan through the sub-channels of an RF channel one at a time, and the comparator 80 may be arranged to compare the reference feature sets corresponding to these sub-channels one at a time to the reference feature set.

Although FIG. 2 depicts the code reader 76 as a separate block, the function of the code reader 76 may be performed by the audio bitstream reader 74. Moreover hardware and/or computer software may be used to perform this and other functions (e.g., the extraction and comparison of feature sets) that are also shown in FIG. 2 as separate blocks. Thus, the block diagram of FIG. 2 provides a schematic depiction of the functions performed by the digital measurement device 42, and should not be understood to limit the invention to a specific hardware and/or software configuration.

In order to compare the test feature set, which is extracted by the test feature extractor 62 from the audio signal representative of a tuned program, to the reference feature set, which is extracted by the audio bitstream reference feature extractor 78 from a program carried in one of the channels available to the monitored digital receiver 34, the scanning tuner of the tuner and demodulator 70 may be controlled in a manner to more efficiently scan through the available channels with the aim of reducing the time to find a match. For example, the last several channels or programs to which the monitored digital receiver 34 was tuned may be scanned before the remaining channels or programs are scanned. Alternatively, a set of favorite stations or channels or programs may be prestored in the digital measurement device 42 by the audience member 22, and these favorite stations or channels or programs may be scanned before the remaining stations or channels or programs are scanned. As a further alternative, the digital measurement device 42 may be arranged to intercept tuning signals from the remote control that is used by the audience member 22 to control the monitored digital receiver 34 so that scanning begins with the channel corresponding to the intercepted remote control signals. These alternatives can be used alone or in combination, and/or any artificial intelligence algorithms that forecast the likelihood of an audience's tuning choices can be used.

As noted above, it is known to use measurement apparatus to compare a signal selected for output by a viewer to each of the signals available at that viewing site. For this purpose, it is known to use a scanning tuner to sequentially tune to each of the signals available at the viewing site, and to compare each of these signals selected by the scanning tuner, one at a time, to an output of the receiver representative of the program to which the receiver is tuned. When a match is found, the channel of the scanning tuner is noted and may be used to determined the program being viewed. This channel may be stored and later transmitted to the central office 18 where the channel data can be compared with a separately compiled program listing in order to determine the identity of the program carried on that channel at that time.

The present system avoids the problems inherent in setting up and managing a program listing function by determining both the source (channel, television input, etc.) and the encoded identity of the program being measured by reading a code from the program corresponding to a comparison match. However, in the event that a code is not found in a program, the system of the present invention can default to the prior art mode and transmit a source-oriented datum (such as a channel datum) to the central office 18.

In a preferred embodiment of the invention, the feature extraction and comparison operations described above are carried out so as to determine a similarity between a short test period of sound and a correspondingly short reference period of sound, so as to compensate for the possible delay introduced by the digital receiver, and so as to control the scanning. Similarity between short test and reference periods of sound is determined by comparing their power spectra in a frequency domain. However, it should be understood that other comparison techniques may be used. Additionally, delay compensation may be provided by efficiently computing the power spectra, and scanning may be controlled by utilizing the current similarity determination to direct which reference will be scanned next so that the average time resolution is minimized.

In a preferred embodiment of the invention, the feature extraction and comparison operations are carried out by performing a Modified Discrete Cosine Transform (MDCT) or a Fast Fourier Transform (FFT) in order to generate test and reference spectra which are then compared to determine if they match. Accordingly, the test audio signal of the program being viewed, as derived, for example, by the microphone 46, is digitized and its spectrum, obtained by a Modified Discrete Cosine Transform (MDCT) performed by the test feature extractor 62, is compared with a similar MDCT spectrum obtained by the audio bitstream reference feature extractor 78 from the output of the tuner and demodulator 70.

The power spectrum method of program matching offers several advantages. For example, very short segments, on the order of 64 msec, of the test and reference audio signals are adequate to indicate a mismatch between test and reference signal streams at that instance. As is well known in the art, the minimum resolvable time of a tuning measurement can become unacceptable if long segments are required. The power spectrum method also reduces the impact of intentional and unintentional distortions introduced by the regeneration of audio inside of the television, as well as added environmental noises picked up by the microphone. Moreover, the spectrum computation at each possible delay can be efficiently carried out by removing the contributions of a few audio data samples from a previous delay and by adding a few new audio data samples representing the current delay through the use of a sliding transformation discussed below. Furthermore, the power spectrum method is independent of signal level. Also, this method produces a high correlation score when the test and reference signals match.

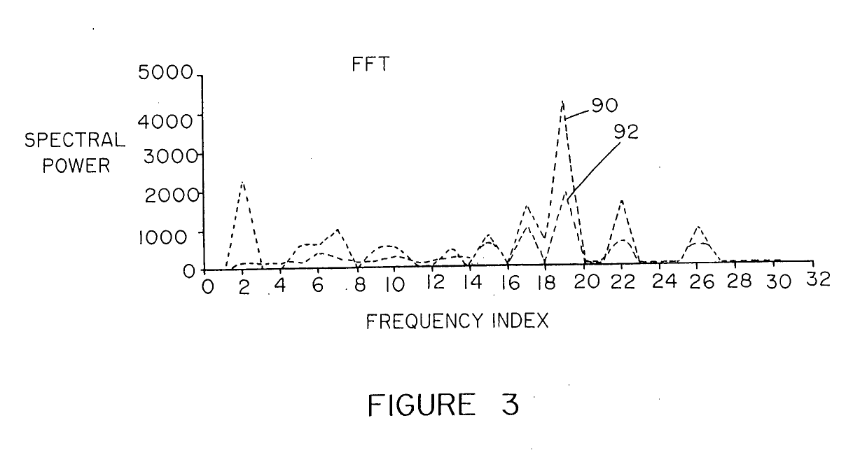

As an example, the test feature extractor 62 and the audio bitstream reference feature extractor 78, when arranged to produce power spectra by the use of a Fast Fourier Transform (FFT), may produce corresponding power spectra 90 and 92 as shown in FIG. 3, it being understood that these feature extractors could have otherwise been implemented to produce power spectra by the use of an MDCT. A measurement is made by the test feature extractor 62 to acquire test audio data for a period time no less than the delay introduced by the monitored digital receiver 34 at a sampling rate of 8 kHZ. Then, a series of test power spectra, such as the test power spectrum 90, is generated by applying a sliding FFT to the sampled audio data, where each test power spectrum corresponds to a 512-sample block, and where each test power spectrum corresponds to a delay of the monitored digital receiver 34. On the reference side, a 512-sample block is read by the audio bitstream reader 74 for each audio program in the current digital stream. Each such block is converted into a reference power spectrum, such as the reference power spectrum 92, by the audio bitstream reference feature extractor 78 using the FFT.

One of the reference audio blocks and one of the test audio blocks may be denoted as follows:

R={r₀, . . . , rⱼ, . . . , r₅₁₁}

and

T={t₀, . . . , tⱼ, . . . , t₅₁₁}

where rⱼ and tⱼ are the j^{th} audio sample of the reference block R and the test block T, respectively. The corresponding power spectra of these blocks are denoted as follows:

P(R)={p₀, . . . , pᵢ, . . . , p₂₅₅}

and

P(T)={q₀, . . . , qᵢ, . . . , q₂₅₅}

where pᵢ and qᵢ are the power of the frequency components corresponding to an index i in the reference and test blocks R and T, respectively. The index i may be related to frequency, for example, by the following equation:

$$f = \frac{4 i}{255}$$

The similarity or correlation between the two audio blocks is then computed by the comparator 80 according to the following equation:

$$s ( R , T ) = S ( P ( R ) , P ( T ) ) = \frac{{\sum }_{j = m}^{n} \vert {p}_{j + 1} - {p}_{j} \vert \cdot V ( {P}_{j + 1} - {p}_{j} , {q}_{j + 1} - {q}_{j} )}{{\sum }_{j = m}^{n} \vert {p}_{j + 1} - {p}_{j} \vert}$$

where 0≦m<n≦254, and where V(x,y) is a weighting function given by the following equation:

$$V ( x , y ) = \{ \begin{matrix}1 & x \cdot y \geq 0 \\ 0 & x \cdot y < 0\end{matrix}$$

The two equations immediately above effectively compare weighted spectral slopes of the two audio blocks. This comparison is advantageous to overcome noise picked up by the microphone 46 and distortions/special effects generated by the monitored digital receiver 34.

The above similarity measurement is preferable because it works even when ambient noise is mixed into the original signal by the microphone 46, and when distortion is introduced by the set top box 36 or the television 38.

However, this similarity measurement may not be robust enough for some situations because the correlation performed by the comparator 80 relies on a single pair of audio blocks, because these blocks represent an extremely short (˜64 ms) segment of the corresponding signals, and because one or both of the signals may be corrupted by the ambient noise to such an extent that an accidental and mistaken correlation can result. In order to achieve a robust similarity measurement, m successive pairs of audio blocks may be correlated by the comparator 80. Such m successive pairs of audio blocks may be designated as follows:

(Rₗ, Tₗ), . . . , (Rᵢ, Tᵢ), . . . , (Rₘ, Tₘ)

where Rᵢ designates the i^{th} reference block and Tᵢ designates the i^{th} test block. The comparator 80 then computes a matching score M(R,T) according to the following equation:

$$M ( R , T ) = \frac{1}{m - n} {\sum }_{j = 1}^{m - n} {S}_{j}$$

where Sⱼ is the j^{th} best similarity among m similarities, and where n is the number of non-matching blocks out of m blocks. If M(R,T)>K (where K is a threshold having a value, for example, of 0.8), the reference and test audio signals match. For m=6, for example, R and T represent a total duration of 384 ms. For such a time resolution, good results can be obtained by selecting n=2.

It is possible that the above formulation can produce false matches where the audio content is noise-like or is silent. If noise-like or silent audio blocks cause false matches, incorrect code may be reported. Moreover, if noise-like or silent blocks fail to produce any matches at all, there may be a substantial passage of time before the reporting of a correct code identifying the channel, station, or program to which the tuner and demodulator 70 is tuned. Thus, the comparator 80 may be arranged to detect both situations and react to them differently.

For example, a test audio block T may be determined to be noise-like if the standard deviation of its power spectrum is less than a threshold Kₙ, and a test audio block T may be determined to be silent if the following relationship is satisfied:

$${\sum }_{i = s}^{255} {q}_{i} < {K}_{s}$$

where qᵢ is the power of the frequency component corresponding to the index i in the test block T, s is the index corresponding to a particular frequency, and Kₛ is a threshold. A noise-like and/or silent reference block R can be determined similarly.

The detection of silence with respect to data from the audio output coupling 47 or the microphone 46 can also be used by the on/off processor 55 to decide if the television 38 is on or off. If silence has been successively detected for more than Nₛ blocks, then the television 38 is regarded as being off Nₛ blocks ago.

The set top box 36 or the television 38 introduces a delay that varies from receiver to receiver. To overcome this delay problem, the test feature extractor 62 may be arranged to sample the audio for a duration much longer than 384 ms. For example, the test feature extractor 62 may be arranged to sample the audio for a duration of two seconds. If so, a set of test samples may be denoted as follows:

D={d₀, . . . , dₖ, . . . , d_{M}}

where dₖ is the k^{th} sample, and M+1 is the total number of samples d, which equals the sample rate times the sample duration. For an 8 kHz sampling rate and a two second duration, a value M=(8000)(2)=16000. From the set D above, different test audio blocks T_{d} are formed according to the following:

T_{d}={d_{0+d}, . . . , d_{j+d}, . . . , d_{511+d}}.

Each test block T_{d} corresponds to a possible delay. There are M−(512)(m) possible delays or, according to the above example, 16000−512*6=12928 possible delays. A similarity score between a test signal D and a reference signal R may be denoted score(D,R) and is computed according to the following equation:

$$score ( D , R ) = {max}_{0 \leq d \leq M - 512 m} ( M ( R , {T}_{d} ) ) .$$

Because D remains invariant for different reference audio blocks, the comparator 80 only computes the spectra of D once, and then compares D to all reference features. In other words, the comparator 80 compares a test signal with many reference signals in parallel. An efficient way to compute the spectra of D is to use a sliding FFT, as described hereinafter.

To handle all of the above situations, the comparator 80 uses a novel approach in order to shorten the time during which TV viewing is unknown. In this novel approach, the comparator 80 directs its actions (the reporting of viewing and the setting of the tuner and demodulator 70) based not only on its comparison results (Same, Noise, SilentRT, SilentT, Different) but also on its states (S, V, W, O) as well as on the values of two counters (nCount and sCount). Accordingly, the comparator 80 operates in accordance with the following state table:

| | S | V | W | | O |
|---|---|---|---|---|---|
| Same | Report (code) | Report (code) | Report (code) | | Report (code) |
| | State=V | | State=V | | State=V |
| | 1 | 2 | | | |
| Different | ScanNext ( ) | State=S | State=S | | Report (TVOn) |
| | Report (end) | Report (end) | ScanNext ( ) | | State=S |
| | 3 | 4 | Report (end) | | ScanNext ( ) |
| | | | | | 5 |
| Noise | State=W | State=W | nCount= | | Report (TVOn) |
| | Thres=T0 | Thres=T1 | nCount+1 | | State=S |
| | nCount=1 | nCount=1 | If (nCount > | | |
| | | | Thres) { | | |
| | | | Report (end) | | |
| | | | State=S | | |
| | | | ScanNext ( ) | | |
| | 6 | 7 | } | 8 | |
| SilentRT | Thres=T2 | Thres=T3 | sCount= | | OffProcess ( ) |
| | State=W | State=W | sCount+1 | | |
| | nCount=1 | sCount=1 | If (sCount > | | |
| | | | Thres) { | | |
| | | | Report (end) | | |
| | | | State=S | | |
| | | | ScanNext ( ) | | |
| | 9 | 10 | } | 11 | 12 |

| | | | | |
|---|---|---|---|---|
| SilentT | sCount= | Same as Left | sCount= | OffProcess ( ) |
| | sCount+1 | | sCount+1 | |
| | Thres=T4 | | If (sCount > | |
| | State=W | | Thres) { | |
| | | | Report (Audio | |
| | | | _Off) | |
| | | | State=O | |

| | | |
|---|---|---|
| 13 | } | 14 |

In the above table, the states of the comparator 80 are search, verification, wait-to-see, and audio-off denoted as S, V, W, and O, respectively, and its comparison results are Same, Different, Noise, SilentRT, and SilentT. SilentRT designates that both the test signal and reference are silent, and SilentT designates that only the test signal is silent. A counter nCount records the number of consecutive times that the comparator 80 returns Noise as a result. A counter sCount records the number of consecutive times that the comparator 80 returns SilentRT or SilentT as a result. The matching threshold for Same is lower if the comparator 80 is in the state V than if the comparator 80 is in the state S.

When the tuner and demodulator 70 is tuned to the same channel as the television 38, some of the results will be Noise because noise is a genuine part of the audio, and because short time spans of signature extractions makes normal sound noise-like. However, Noise cannot be used to conclude that the test signal and the reference signal match because other programs contain noise as well. Nevertheless, there is a higher probability that the subsequent signatures will be matched as Same if they are the same because a program will not be all noise. This higher probability suggests that the tuner and demodulator 70 need not be changed until more data is observed.

The thresholds T0 and T1 may be used to regulate the maximum number of times that a current channel will be observed if all matching results in Noise. If the current program has never been matched as Same so far, the chances that they are the same will be smaller that is otherwise the case. Thus, matching is continued for time T0. Otherwise, matching is continued for time T1. This same discussion applies to the matching results SilentRT using the thresholds T2 and T3.

Accordingly, the comparison performed by the comparator 80 is extended from the traditional two-mode operation to that of fourteen modes. These modes are denoted with corresponding numbers in the above table. The advantages of the fourteen-mode operation include the following:

1) The time needed to match a program is adaptive to the content of that program. Thus, distinctive audio takes a shorter time to match than a less distinctive one. On the other hand, the traditional two-mode approach uses equal amounts of time for all programs regardless of the audio content, and this amount of time has to be as long as required for the worst case.

2) The fourteen-mode approach shortens the average amount of time that television viewing is unknown. When Noise or SilentRT periods happen, the traditional two-mode approach will mark (NumberOfChannels−1)(TimeonEachChannel) seconds as unknown viewing, while the new fourteen-mode approach wastes at most (T1)(TimeOnEachChannel) seconds. In practice, (NumberOfChannels−1) is much greater than T1. Thus, the amount of unknown viewing time is significantly shortened with the new fourteen-mode approach.

3) The present invention has a built-in audio-off detection. When audio-off is detected, Offprocess() can be invoked to handle all other system tasks.

A few examples may be useful in understanding the above table. If the comparator 80 is in state S and detects a match between the test and reference feature sets (Same), the comparator 80 reports the code read by the code reader 76 and transitions to state V. If the comparator 80 is in state V and detects Noise when comparing the test and reference feature sets, the comparator 80 sets the value of Thres to T1, sets the value of the counter nCount to one, and transitions to state W. If the comparator 80 is in state W and detects that both the test signal and reference signal are silent (SilentRT), the comparator 80 increments the count of the counter sCount by one and compares the current count of the counter sCount to the value of Thres. If the current count of the counter sCount exceeds the value of Thres, the comparator 80 transitions to state S and scans to the next channel. If the current count of the counter sCount does not exceed the value of Thres, the comparator 80 remains in state W. The comparator 80 transitions to state O whenever the count of consecutive SilentT exceeds a predefined threshold T4 or whenever the on/off signal 53 indicates off.

The sliding FFT mentioned above can be implemented according to the following steps:

STEP 1: Compute the Fourier transform of the first block of data using FFT.

STEP 2: the skip factor k (which, for example, may be eight) of the Fourier Transform is applied according to the following equation in order to modify each frequency component F_{old}(u₀) of the spectrum corresponding to the initial sample block in order to derive a corresponding intermediate frequency component Fₗ(u₀):

$${F}_{1} ( {u}_{0} ) = {F}_{old} ( {u}_{0} ) exp - ( \frac{2 π {u}_{0} k}{N} ) i$$

where i represents the square root of −1, where u₀ is the frequency index of interest, and where N is the size of a block used in the equation immediately above and may, for example, be 512. The frequency index u₀ varies, for example, from 45 to 70. It should be noted that this first step involves multiplication of two complex numbers.

STEP 3: the effect of the first k samples of the old N sample block is then eliminated from each Fₗ(u₀) of the spectrum corresponding to the initial sample block and the effect of the eight new samples is included in each Fₗ(u₀) of the spectrum corresponding to the current sample block increment in order to obtain the new spectral amplitude F_{new}(u₀) for each frequency index u₀ according to the following equation:

$${F}_{new} ( {u}_{0} ) = {F}_{1} ( {u}_{0} ) + {\sum }_{m = 1}^{m = k} ( {f}_{new} ( m ) - {f}_{old} ( m ) ) - exp - ( \frac{2 π {u}_{0} ( k - m + 1 )}{N} ) i$$

where i again represents the square root of −1, where fold and f_{new} are the time-domain sample values. It should be noted that this second step involves the addition of a complex number to the summation of a product of a real number and a complex number. This computation is repeated across the frequency index range of interest (for example, 45 to 70) to provide the Fourier Transform of the new audio block.

As indicated above, a Modified Discrete Cosine Transform, which is well known in the digital signal processing arts, can be used in the foregoing method instead of a FFT.

The television tuning measurement provided by the present invention is non-intrusive, thus avoiding any risk of damage to a panelist's equipment by an installer who might otherwise have to open the panelist's equipment in order to attach tuning measurement devices thereto. For example, the microphone 46 is used to non-intrusively acquire the audio output of the monitored digital receiver 34 for processing by the test feature extractor 62. As another example, the audio output coupling 47 may be made to an audio signal output connector (e.g., an audio output jack, or the like) of the monitored digital receiver 34 in order to non-intrusively acquire its audio output for processing by the reference feature extractor 66.

Also, the ability to clearly identify programs at the point of audience measurement in accordance with the present invention offers an economic benefit to the researcher by allowing the researcher to avoid the costs of operating a separate measurement system for associating named programs with some sort of intermediate household tuning datum.

Moreover, the present invention is compatible with existing systems used for measuring analog broadcasts. That is, inasmuch as both analog and digital broadcasting will occur and both analog and digital receivers will be encountered during an extensive transition period, it is clearly desirable to be able to install a single suite of measurement equipment in a statistically selected dwelling, rather than having two sets of equipment producing two sets of data that have to be reconciled in a central facility.

Certain modifications of the present invention have been discussed above. Other modifications will occur to those practicing in the art of the present invention. For example, the comparator 80 may include a programmed microprocessor in order to control the various operations of the digital measurement device 42.

Also, when comparing the test and reference power spectra, their slopes may be compared and are considered to match if they have the same sign. However, other matching algorithms may be performed. For example, amplitudes may be compared at selected frequencies, or slopes may be matched based on other criteria such as magnitude of the corresponding slopes.

Moreover, although the present invention has been particularly described above in connection with televisions, it should be appreciated that the present invention may be used in connection with other devices such as radio, VCRs, DVDs, etc.

Furthermore, the present invention has been described above in the context of detecting tuning selections in the statistically selected dwelling 14. However, the present invention may be used for other applications, such as detecting and/or verifying the distribution of programs, determining the distribution routes of programs, etc.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

What is claimed is:

1. A method for determining which of a plurality of programs has been selected to be received by a monitored receiver, wherein each of the programs has an audio signal portion and is transmitted as a sequence of data packets in a corresponding channel, and wherein the monitored receiver has a receiver audio output representative of an audio signal portion of the selected program, the method comprising the following:
a) comparing the receiver audio output with the audio signal portion of each of the programs until a match is found;
b) reading an identifying code from one of the data packets associated with the matching program; and,
c) storing the identifying code as a time-stamped record in a memory apparatus.

2. The method of claim 1 wherein the receiver audio output comprises an audible acoustic signal, and wherein a) comprises the following:
a1) acquiring, by way of a non-invasive sensor disposed adjacent the monitored receiver, the receiver audio output from the audible acoustic signal; and,
a2) comparing the acquired receiver audio output with respective audio signal portions of each of the programs until a match is found.

3. The method of claim 1 wherein a) comprises scanning the audio signal portions based on historical tuning of the monitored receiver.

4. The method of claim 1 wherein a) comprises scanning the audio signal portions based on a list of favorite stations or channels or programs.

5. The method of claim 1 wherein a) comprises scanning the audio signal portions based on intercepted remote control signals.

6. The method of claim 1 wherein a) comprises scanning the audio signal portions based forecasts of the likelihood of tuning choices.

7. The method of claim 1 wherein b) comprises the following:
b1) demulitplexing a time-division multiplexed sequence of data packets in order to generate a transport bitstream associated with the program matching the receiver audio output; and,
b2) reading the identifying code from the transport bitstream.

8. The method of claim 1 wherein a) comprises the following:
a1) selecting a channel or source;
a2) digitizing the receiver audio output;
a3) applying a first transform to the digitized receiver audio output in order to obtain a receiver audio output spectrum;
a4) applying a second transform to the audio signal portion of one of the plurality of the programs in the selected channel or source in order to generate a corresponding audio signal portion spectrum;
a5) comparing the receiver audio output spectrum and the audio signal portion spectrum to thereby generate a single aggregate matching score;
a6) if the score exceeds a predetermined value, deciding that the match has been found; and,
a7) if the score does not exceed the predetermined value, selecting a different one of the plurality of programs and repeating a4) through a7), as necessary.

9. The method of claim 8 wherein a) further comprises returning to a1) if a6) and a7) do not result in a match.

10. The method of claim 8 wherein the first and second transforms are the same transforms.

11. The method of claim 10 wherein each of the first and second transforms is a Modified Discrete Cosine Transform.

12. The method of claim 10 wherein each of the first and second transforms is a Fast Fourier Transform.

13. The method of claim 8 wherein a5) comprises comparing the receiver audio output spectrum and the audio signal portion spectrum at each of a plurality of frequencies.

14. The method of claim 8 wherein at least one of the first and second transforms is derived from less than 400 ms of a corresponding signal.

15. The method of claim 1 wherein a) comprises the following:
a1) digitizing at least a portion of the receiver audio output; and,
a2) extracting a feature set from the digitized portion, wherein the digitized portion is at least as long as is needed for the feature set plus a delay introduced by the monitored receiver.

16. The method of claim 1 wherein a) comprises comparing the receiver audio output with the audio signal portion to produce a same output when the receiver audio output and the audio signal portion match, a difference output when the receiver audio output and the audio signal portion do not match, a noise output when at least one of the receiver audio output and the audio signal portion is noisy, and a silent output when at least one of the receiver audio output and the audio signal portion is silent.

17. The method of claim 16 wherein a) comprises counting silent and noisy blocks of at least one of the receiver audio output and the audio signal portion.

18. The method of claim 16 wherein a) comprises transitioning between search, verification, wait-to-see, and audio-off states.

19. The method of claim 1 wherein a) comprises comparing weighted slopes of the receiver audio output with weighted slopes of the audio signal portion.

20. The method of claim 1 wherein a) comprises transitioning between search, verification, wait-to-see, and audio-off states.

21. An apparatus for identifying a program selected for reception on a monitored receiver having an audio output, wherein the selected program comprises one of a plurality of receivable programs, wherein each of the plurality of receivable programs is distributed as a time-division sequence of data packets at a corresponding one of a plurality of radio frequencies, the apparatus comprising:
a tuner and demodulator arranged to receive a predetermined one of the receivable programs;
a first feature extractor arranged to extract a first set of characteristic features from the audio output;
a second feature extractor arranged to extract a second set of characteristic features from the predetermined program;
a comparator arranged to compare the first and the second sets of characteristic features and to determine if the first and the second sets of characteristic features match;
a code extractor arranged to extract a program identifying code from the predetermined program.

22. The apparatus of claim 21 wherein the comparator comprises a microprocessor.

23. The apparatus of claim 21 further comprising a microphone disposed adjacent the monitored receiver, wherein the microphone is arranged to acquire the audio output of the monitored receiver.

24. The apparatus of claim 21 further comprising a coupling to an audio output connector of the monitored receiver, wherein the coupling is arranged to acquire the audio output of the monitored receiver.

25. The apparatus of claim 21 wherein the tuner and demodulator includes a scanning tuner arranged to scan through the plurality of programs and to provided the scanned programs to the second feature extractor.

26. The apparatus of claim 25 wherein the scanning tuner is arranged to scan through the plurality of programs based on historical tuning of the monitored receiver.

27. The apparatus of claim 25 wherein the scanning tuner is arranged to scan through the plurality of programs based on a list of favorite stations or channels or programs.

28. The apparatus of claim 25 wherein the scanning tuner is arranged to scan through the plurality of programs based on an intercepted remote control signal.

29. The apparatus of claim 25 wherein the scanning tuner is arranged to scan through the plurality of programs based on forecasts of the likelihood of tuning choices.

30. The apparatus of claim 21 wherein the second feature extractor is arranged to demultiplex a time-division multiplexed sequence of data packets in order to generate a transport bitstream associated with the program matching the receiver audio output, and wherein code extractor is arranged to extract a program identifying code from the transport bitstream.

31. The apparatus of claim 21 wherein:
the first feature extractor is arranged to digitize the audio output and to apply a first transform to the digitized audio output in order to obtain a receiver audio output spectrum;
the second feature extractor is arranged to apply a second transform to audio signal portions of each of the programs in order to generate a program spectrum;
the comparator is arranged to compare the receiver audio output spectrum and the program spectrum to thereby generate a single aggregate matching score;
if the score exceeds a predetermined value, the comparator is arranged to decide that the match has been found; and,
if the score does not exceed the predetermined value, the comparator is arranged to select a different one of the programs and to repeat the comparison of the receiver audio output spectrum and the program spectrum, as necessary.

32. The apparatus of claim 31 wherein the first and second transforms are the same transform.

33. The apparatus of claim 32 wherein each of the first and second transforms is a Modified Discrete Cosine Transform.

34. The apparatus of claim 32 wherein each of the first and second transforms is a Fast Fourier Transform.

35. The apparatus of claim 31 wherein the comparator is arranged to compare the receiver audio output spectrum and the program spectrum at each of a plurality of frequencies.

36. The apparatus of claim 31 wherein at least one of the first and second transforms is derived from less than a predetermined time of a corresponding signal.

37. The apparatus of claim 21 further comprising a memory arranged to store the program identifying code as a time-stamped record.

38. The apparatus of claim 21 wherein the code extractor is arranged to extract the program identifying code only if the first and the second sets of characteristic features match.

39. The apparatus of claim 21 wherein the first feature extractor is arranged to digitize at least a portion of the receiver audio output and to extract a feature set from the digitized portion, wherein the digitized portion is at least as long as is needed for the feature set plus a delay introduced by the monitored receiver.

40. The apparatus of claim 21 wherein the comparator is arranged to compare the first and second sets of characteristic features so as to produce a same output when the first and second sets of characteristic features match, a difference output when the first and second sets of characteristic features do not match, a noise output when at least one of the first and second sets of characteristic features is noisy, and a silent output when at least one of the first and second sets of characteristic features is silent.

41. The apparatus of claim 40 wherein the comparator comprises silent and noisy blocks counters for at least one of the first and second sets of characteristic features.

42. The apparatus of claim 40 wherein the comparator transitions between search, verification, wait-to-see, and audio-off states.

43. The apparatus of claim 21 wherein the comparator compares weighted slopes of the first and second sets of characteristic features.

44. The apparatus of claim 21 wherein the comparator transitions between search, verification, wait-to-see, and audio-off states.

45. A method for determining which of a plurality of programs has been selected to be received by a monitored receiver, wherein each of the programs is transmitted as a sequence of data packets in a corresponding channel, and wherein the monitored receiver has a receiver output representative of the selected program, the method comprising the following:
a) comparing the receiver output with each of the plurality of programs until a match is found; and,
b) reading an identifying code from one of the data packets associated with the matching program.

46. The method of claim 45 wherein a) comprises the following:
a1) acquiring, by way of a non-invasive sensor disposed adjacent the monitored receiver, the receiver output; and,
a2) comparing the acquired receiver output with each of the plurality of programs until a match is found.

47. The method of claim 45 wherein a) comprises scanning the plurality of programs based on historical tuning of the monitored receiver.

48. The method of claim 45 wherein a) comprises scanning the plurality of programs based on a list of favorite stations or channels or programs.

49. The method of claim 45 wherein a) comprises scanning the plurality of programs based on intercepted remote control signals.

50. The method of claim 45 wherein a) comprises scanning the plurality of programs based on forecasts of the likelihood of tuning choices.

51. The method of claim 45 wherein a) comprises the following:
a1) applying a first transform to the receiver output in order to obtain a receiver output spectrum;
a2) applying a second transform to one of the plurality of the programs in order to generate a corresponding signal portion spectrum;
a3) comparing the receiver output spectrum and the signal portion spectrum to thereby generate a score;
a4) if the score exceeds a predetermined value, deciding that a match has been found; and,
a5) if the score does not exceed the predetermined value, deciding that a match has not been found, selecting a next one of the plurality of programs and repeating at least a2) through a5).

52. The method of claim 51 wherein the first and second transforms are the same transform.

53. The method of claim 52 wherein each of the first and second transforms is Modified Discrete Cosine Transform.

54. The method of claim 52 wherein each of the first and second transforms is a Fast Fourier Transform.

55. A method for determining which of a plurality of programs has been tuned by a monitored receiver, wherein each of the programs is transmitted as a sequence of data packets in a corresponding channel, and wherein the monitored receiver has a receiver output representative of the selected program, the method comprising the following:
a) determining a test power spectrum based upon the receiver output;
b) determining a plurality of reference power spectra based upon the plurality of programs;
c) comparing the test power spectrum with each of the reference power spectra, as necessary, to determine a match; and,
d) determining an identification indicia based upon the match.

56. The method of claim 55 wherein a) comprises applying a first transform to the receiver output in order to obtain the test power spectrum, and wherein b) comprises applying a second transform to the plurality of programs in order to generate the plurality of reference power spectra.

57. The method of claim 56 wherein the first and second transforms are the same transform.

58. The method of claim 57 wherein each of the first and second transforms is a Modified Discrete Cosine Transform.

59. The method of claim 57 wherein each of the first and second transforms is a Fast Fourier Transform.

60. The method of claim 55 wherein the identification indicia is a channel to which the monitored receiver is tuned.

61. The method of claim 55 wherein the identification indicia is a program label associated with a program to which the monitored receiver is tuned.

62. The method of claim 55 wherein the identification indicia is a station associated with a channel to which the monitored receiver is tuned.

63. The method of claim 55 wherein a) comprises determining n test power spectra based upon n sample blocks of the receiver output, wherein b) comprises determining n reference power spectra based upon one of the plurality of programs, wherein c) comprises comparing the n test power spectra with the n reference power spectra to form a single match score, and wherein d) comprises determining an identification indicia based upon the single match score.

64. The method of claim 55 wherein a) comprises determining n+m test power spectra based upon n+m sample blocks of the receiver output, wherein b) comprises determining n reference power spectra based upon one of the plurality of programs, wherein c) comprises comparing the n+m test power spectra with the n reference power spectra to form a single match score, and wherein d) comprises determining an identification indicia based upon the single match score.
